(19) United States
(12) Patent Application Publication
(10) Pub. No.: US 2011/0279853 A1
(43) Pub. Date: Nov. 17, 2011

(54) JOB PROCESSING APPARATUS AND JOB PROCESSING METHOD

(75) Inventors: Yuki YAMADA, Shiojiri-shi (JP); Satoshi KOTAKA, Azumino-shi (JP)

(73) Assignee: SEIKO EPSON CORPORATION, Tokyo (JP)

(21) Appl. No.: 13/097,017

(22) Filed: Apr. 28, 2011

(30) Foreign Application Priority Data
May 13, 2010 (JP) 2010-111441

(51) Int. Cl. G06F 3/12

(52) U.S. Cl. 358/1.15

(57) ABSTRACT

A job processing apparatus includes a reception unit which receives a job, a job management unit which holds the received job and manages a processing order of a plurality of jobs held, a job processing unit which sequentially processes the plurality of jobs in accordance with the processing order, and an acceptance unit which accepts a change request of the processing order for changing to an order in which a first job which is being received is processed to before a predetermined second job among the held jobs. In the job processing apparatus, when the acceptance unit has accepted the change request, the job management unit changes the processing order, and when a turn of the processing by the job processing unit comes to the second job before the processing order is changed in accordance with the change request, the job management unit stops the processing by the job processing unit and changes the processing order.

### BACKGROUND

1. Technical Field

The present invention relates to a job processing apparatus and a job processing method.

2. Related Art

There have been proposed various existing methods of receiving and holding a print job and rearranging a printing order of a plurality of print jobs in a print waiting state in a job processing apparatus, for example, a printer and a complex machine (for example, see, JP-A-2006-255956, JP-A-2008-173886, and the like).

JP-A-2006-255956 discloses an invention in which priorities are assigned to the plurality of print jobs in the print waiting state and the printing order is rearranged based on the priorities. Further, JP-A-2008-173886 discloses an invention in which a rearrangement operation of the printing order of print jobs is controlled such that a print job which is not executed indefinitely with the rearrangement operation is not present.

However, in existing methods of rearranging print jobs, only print jobs which have been already received completely by a printer or the like are targeted to be rearranged and a print job which is being received by the printer or the like is not targeted to be rearranged. In such existing methods, the print job which is being received is not even considered as a target to be rearranged.

### SUMMARY

An advantage of some aspects of the invention is to provide a new job processing apparatus and a new job processing method which set a job which is being received by the job processing apparatus such as a printer as a job rearrangement target.

A job processing apparatus according to an aspect of the invention includes a reception unit which receives a job, a job management unit which holds the job received by the reception unit in a memory and manages a processing order of a plurality of jobs held in the memory, a job processing unit which sequentially processes the plurality of jobs in accordance with the processing order, and an acceptance unit which accepts a change request of the processing order for changing to an order in which a first job which is being received by the reception unit is processed before a predetermined second job among the held jobs. In the job processing apparatus, when the acceptance unit has accepted the change request, the job management unit changes the processing order, and when a turn of the processing by the job processing unit comes to the second job before the processing order is changed in accordance with the change request, the job management unit stops the processing by the job processing unit and changes the processing order.

Further, in the job processing apparatus according to the aspect of the invention, it is preferable that when the acceptance unit has accepted the change request, the job management unit change the processing order after the first job has been completely received, and when a turn of the processing by the job processing unit comes to the second job while waiting for the reception completion, the job management unit stop the processing by the job processing unit and change the processing order after the first job has been completely received.

Further, in the job processing apparatus according to the aspect of the invention, it is preferable that the job management unit judge whether or not a resource of the memory runs short while the processing by the job processing unit is stopped and when it has been judged that the resource runs short, the job management unit restart the processing by the job processing unit and do not change the processing order in accordance with the change request of the processing order.

Further, in the job processing apparatus according to the aspect of the invention, it is preferable that the job management unit judge whether or not a resource of the memory runs short while the processing by the job processing unit is stopped and when it has been judged that the resource runs short and a third job which is to be processed subsequent to the second job is held in the memory, the job management unit change information of the second job to information of the third job in the change request and change the processing order after the first job has been completely received.

Further, in the job processing apparatus according to the aspect of the invention, it is preferable that the job processing apparatus include an external storage medium which is detachable, and when a turn of the processing by the job processing unit comes to the second job while waiting for the reception completion, the job management unit swap out at least one job held in the memory to the external storage medium.

Further, in the job processing apparatus according to the aspect of the invention, it is preferable that the job processing apparatus further include a display unit which displays a result of the change of the processing order by the job management unit.

A job processing method according to another aspect of the invention includes receiving a job, holding the received job in a memory and managing a processing order of a plurality of jobs held in the memory, sequentially processing the plurality of jobs in accordance with the processing order, accepting a change request of the processing order for changing to an order in which a first job which is being received is processed before a predetermined second job among the held jobs, and when the change request has been accepted, executing the change of the processing order, and when a turn of the processing comes to the second job before the processing order is changed in accordance with the change request, stopping the processing of the second job and executing the change of the processing order.

### BRIEF DESCRIPTION OF THE DRAWINGS

The invention will be described with reference to the accompanying drawings, wherein like numbers reference like elements.

FIG. 1 is a schematic diagram illustrating a hardware configuration of a printing system according to the embodiment.

FIG. 2 is a diagram illustrating an example of a schematic functional configuration of a printing apparatus according to the embodiment.

FIG. 3 is a diagram illustrating an example of a usage state of a memory according to the embodiment.

FIG. 4 is a state transition diagram of a print job according to the embodiment.

FIG. 5 is a diagram illustrating an example of accumulated contents in a print waiting line according to the embodiment.

FIG. 6 is a flowchart illustrating processing contents of a job processing method in the printing apparatus according to the embodiment.

FIG. 7 is a diagram illustrating an example of a time chart when the job processing method is executed according to the embodiment.

FIG. 8 is a flowchart illustrating processing contents of a job processing method in a printing system according to a first variation of the embodiment.

FIG. 9 is a flowchart illustrating processing contents of the job processing method in the printing system according to the first variation of the embodiment.

FIG. 10 is a flowchart illustrating processing contents of a job processing method in a printing system according to a second variation of the embodiment.

### DESCRIPTION OF EXEMPLARY EMBODIMENTS

Hereinafter, a preferred embodiment for carrying out the invention is described with reference to drawings. It is to be noted that in the embodiment, a printing apparatus (printer) is described as an example of a job processing apparatus.

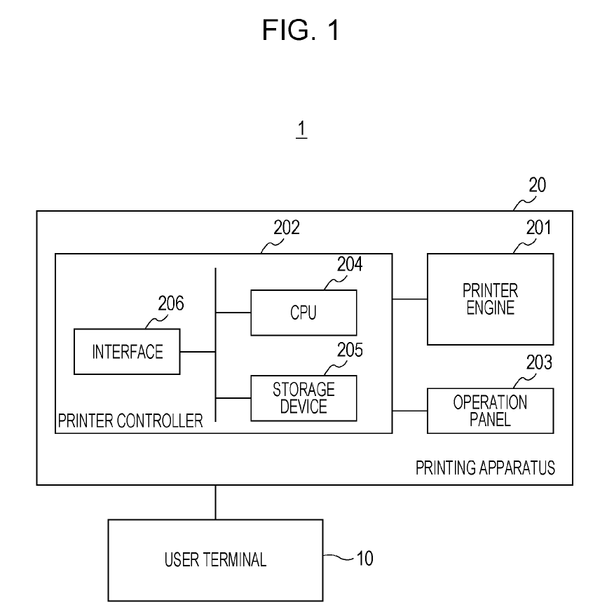

FIG. 1 is a block diagram illustrating a hardware configuration of a printing system 1 according to the embodiment. The printing system 1 is constituted by a user terminal 10 and a printing apparatus 20. The user terminal 10 and the printing apparatus 20 are connected to each other through communication network in a communicable manner.

The user terminal 10 is a device which generates a print job and transmits the print job to the printing apparatus 20. The user terminal 10 functions as a host device for the printing apparatus 20. It is to be noted that the configuration and functions of the user terminal 10 can be made to be the same as those of a typical user terminal.

The printing apparatus 20 is an apparatus which receives a print job from the user terminal 10 so as to execute a printing processing. Further, the printing apparatus 20 has a function of managing a processing order of a plurality of print jobs in a print waiting state and accepting a user input to rearrange the processing order. The printing apparatus 20 includes a printer engine 201, a printer controller 202, and an operation unit 203 as hardware illustrated in FIG. 1. The printer controller 202 and the operation unit 203 may be configured separately from the printing apparatus 20.

The printer engine 201 receives print data to execute a printing processing. It is to be noted that the printer engine 201 can be made to have the same functional operation as that of a printer engine in typical printing apparatuses such as an ink jet printer and a laser printer.

The operation unit (operation panel) 203 is an input unit for inputting an instruction from a user and is constituted by a liquid crystal display, an operation button, and the like. For example, a user operates an operation button on the operation unit 203 so that the user selects a print job of which printing order is desired to be rearranged. With this, the printing order of the selected print job can be determined. It is to be noted that the operation unit 203 itself has the same functional configuration as an operation unit used in the existing printer.

The printer controller 202 executes various processings on the entire printing apparatus 20. The printer controller 202 includes a CPU 204, a storage device 205, an interface 206, and the like. The CPU 204 reads out computer programs stored in the storage device 205 to execute various processings. For example, the interface 206 includes an I/F such as Ethernet (registered trademark) for connecting the printing apparatus 20 to the user terminal 10 in a communicable manner, an I/F for connecting the printing apparatus 20 to a storage medium such as an USB in a communicable manner, and an I/F for connecting the printing apparatus 20 to a scanner and a facsimile in a communicable manner.

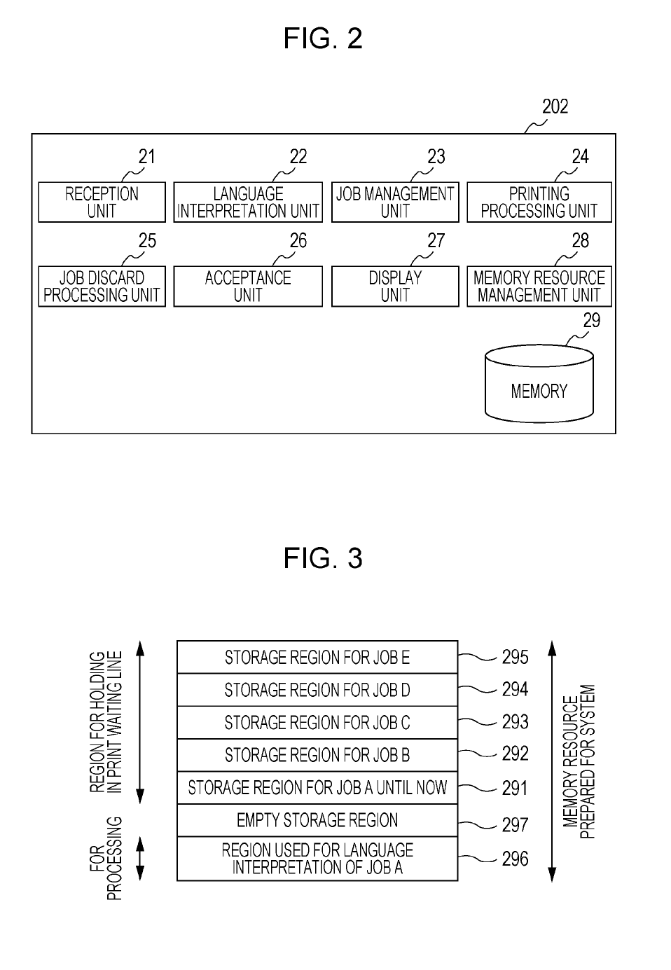

As illustrated in FIG. 2, the printer controller 202 includes a reception unit 21, a language interpretation unit 22, a job management unit 23, a printing processing unit 24, a job discard processing unit 25, an acceptance unit 26, a display unit 27, a memory resource management unit 28, and a memory 29 as functional configurations. It is to be noted that the memory 29 can be realized by using the storage device 205, for example. Further, the CPU 204 mainly executes computer programs stored in the storage device 205 so as to control each hardware so that each part such as the reception unit 21 can be realized.

The reception unit 21 receives a print job transmitted from the user terminal 10. The reception unit 21 transmits the received print job to the language interpretation unit 22.

The language interpretation unit 22 performs a conversion processing (language interpretation) of converting the print job to data which can be printed in the printer engine 201. Further, the language interpretation unit 22 transmits the data of the print job which has been subjected to the conversion processing to the job management unit 23. It is to be noted that the language interpretation unit 22 uses a part of a storage region of the memory 29 through the memory resource management unit 28 when the print job is subjected to the conversion processing.

The job management unit 23 holds data of a print job which has been subjected to the language interpretation by the language interpretation unit 22 to job-manage a processing order of the plurality of print jobs held using a print waiting line (print queue). The job management unit 23 transmits a first print job in the print waiting line to the printing processing unit 24. Further, when a change request of the printing order is accepted from the acceptance unit 26, which will be described later, the job management unit 23 controls to change the processing order (rearrange the order) of print jobs. When the job management unit 23 holds a print job, a storage region of the memory 29 is used through the memory resource management unit 28. It is to be noted that management states of print jobs and the control for changing the processing order of jobs will be described later.

The printing processing unit (job processing unit) 24 transmits the data of the print job received from the job management unit 23 to the printer engine 201 to control a printing processing of the printer engine 201.

The job discard processing unit 25 discards (deletes) the data of the print job which has been completely printed by the printing processing unit 24 from the storage region of the memory 29 through the memory resource management unit 28.

The acceptance unit 26 is a unit for accepting the change request of the printing order (information of order rearrangement) by a user input. The acceptance unit 26 accepts a change request of the processing order for changing to an order in which a print job (first job) which is being received by the reception unit 21 is processed before a predetermined print job (second job) among jobs accumulated in the print waiting line. The acceptance unit 26 transmits the accepted change request of the printing order to the job management unit 23. It is to be noted that the acceptance unit 26 can accept a user input through the operation unit 203.

The display unit 27 displays a list of print jobs in the print waiting line in addition to display items in a typical printing apparatus. Further, the display unit 27 displays states (for example, any one of “printing”, “unprinted” and “receiving”) of the print jobs in the print waiting line. In addition, the display unit 27 can display a result of the change of the processing order by the job management unit 23. For example, the display unit 27 can display print jobs which cannot be rearranged, contents of failure when rearrangement has failed, and the like.

The memory resource management unit 28 receives each usage request of the memory 29 from the language interpretation unit 22, the job management unit 23, the printing processing unit 24, and the job discard processing unit 25. Then, the memory resource management unit 28 manages the memory 29 by storing print jobs in the memory 29, acquiring and deleting the stored print jobs, and so on in accordance with each usage request.

The memory 29 stores programs for executing each processing and print jobs in the print waiting state. Further, the memory 29 is used as a work area for performing the language interpretation on the print job in the language interpretation unit 22. FIG. 3 illustrates a usage example of the memory 29. As illustrated in FIG. 3, the memory 29 is divided into a storage region 291, storage regions 292, 293, 294, 295, a storage region 296, and an empty storage region 297 to be used, for example. Data of a part (a part of a print job A) on which the language interpretation has been performed is stored in the storage region 291. Print jobs B, C, D, E on which the language interpretation has been performed and which have been completely received are stored in the storage regions 292, 293, 294, 295, respectively. The storage region 296 is used for the language interpretation.

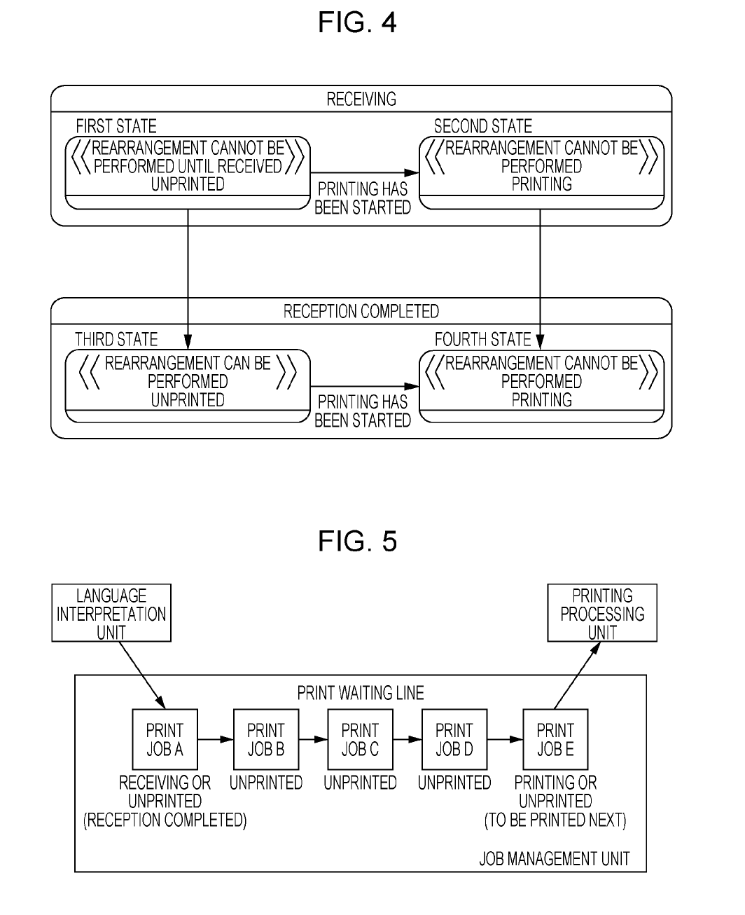

Then, the management states of print jobs in the job management unit 23 are described with reference to FIG. 4. FIG. 4 is a state transition diagram of the print job according to the embodiment.

As illustrated in FIG. 4, management states of a print job X include a first state, a second state, a third state, and a fourth state. The first state is a state where the job management unit 23 receives and stores data of a part of the print job X on which the language interpretation has been performed (a part of the print job X), and the reception unit 21 or the language interpretation unit 22 holds the remaining data. The second state is a state which is shifted from the first state when the print job X has been started to be printed and in which the print job X is being printed while receiving a part of data. The third state is a state which is shifted from the first state when the language interpretation of the print job X has been completed and in which the entire data of the print job X is stored and unprinted. The fourth state is a state which is shifted from the second state when the print job X has been completely received or shifted from the third state when the print job X has been started to be printed and in which data of the print job X is being printed. It is to be noted that the print job X is shifted from the first state to the second state when all of the following three conditions are satisfied. That is, the three conditions include that a turn of the printing processing comes to the print job X in the print waiting line, the printer engine 201 is not in use, and data of the print job (a part of the print job) which is enough for printing, has been received.

When the order of print jobs in each state is rearranged, print jobs in the first state, the second state and the fourth state are not targeted for the rearrangement of the order and only a print job in the third state is targeted for the rearrangement of the order in the existing technique. In contrast, the rearrangement of the order in the embodiment is different from the rearrangement of the printing order in the existing technique in a point that the print job in the first state is also targeted for the rearrangement. The inventors have found that when the print job in the first state is targeted for the rearrangement, there is limitation in a storage space of the memory.

The limitation in the storage space of the memory 29 indicates that there is no guarantee that the printing order of the print job which is being received can be rearranged. The memory 29 needs the storage regions 291 through 296, for example, as described above, and capacities of the storage regions 291 through 296 are changed depending on contents and amounts of data of the print jobs. However, the storage space of the memory 29 is limited. Therefore, there is a possibility that capacities of the storage region 291 for storing a part of a print job and the storage region 296 used for the language interpretation of the print job run short depending on contents or an amount of data of the print job on which the language interpretation has been performed or which is being received. This causes necessity of ensuring the empty storage region 297 by printing a print job in the print waiting state before the print job which is being received and discarding the print job which has been completely printed. Accordingly, there is a case where the printing order cannot be rearranged such that the print job which is being received is started to be printed before the print job in the print waiting state.

In the embodiment, the printing order is controlled to be rearranged in consideration of the limitation and the rearrangement of the printing order in accordance with a request by a user can be realized to the extent as possible.

Next, the control for rearranging the printing order in the job management unit 23 is described with reference to FIG. 5.

The print jobs held in the print waiting line, which are managed by the job management unit 23, can be divided into a print job (A), print jobs (B, C, D) and a print job (E) as illustrated in FIG. 5. The print job (A) is being received or has been completely received but is positioned at the end of the unprinted print waiting line. The print jobs (B, C, D) have been completely received but are unprinted. The print job (E) is being printed currently or is exactly started to be printed.

When rearrangement of the printing order for inserting a print job which is being received to before an unprinted print job is performed, the job management unit 23 changes the processing order after the print job which is being received has been completely received in consideration of the limitation. For example, when the acceptance unit 26 accepts a change request of the printing order for printing the print job A before the print job D, the job management unit 23 waits to change the printing order until the print job A is completely received. Then, the job management unit 23 executes the accepted change request when the print job A has been completely received. At this time, when a turn of the processing by the printing processing unit 24 comes to the print job D before the processing order is changed in accordance with the change request while waiting for the reception completion of the print job A, the job management unit 23 performs the following processing. That is, in this case, the job management unit 23 stops the processing by the printing processing unit 24 and changes the processing order after the print job A has been completely received. Further, the job management unit 23 judges whether or not a resource of the memory 29 runs short while the processing by the printing processing unit 24 is stopped. When the job management unit 23 has judged that the resource runs short, the job management unit 23 performs the following processing. That is, in this case, the job management unit 23 restarts the processing by the printing processing unit 24 and does not change the processing order in accordance with the change request of the processing order.

When rearrangement of the printing order between print jobs which have been completely received but are unprinted is performed, the job management unit 23 instantaneously executes the rearrangement since such rearrangement is a closed processing to be performed in the print waiting line. For example, when the acceptance unit 26 accepts a change request of the printing order for printing the print job B before the print job D, the job management unit 23 changes the printing order. As a result, a print job which is transmitted to the printing processing unit 24 subsequent to the print job E can be set to the print job B.

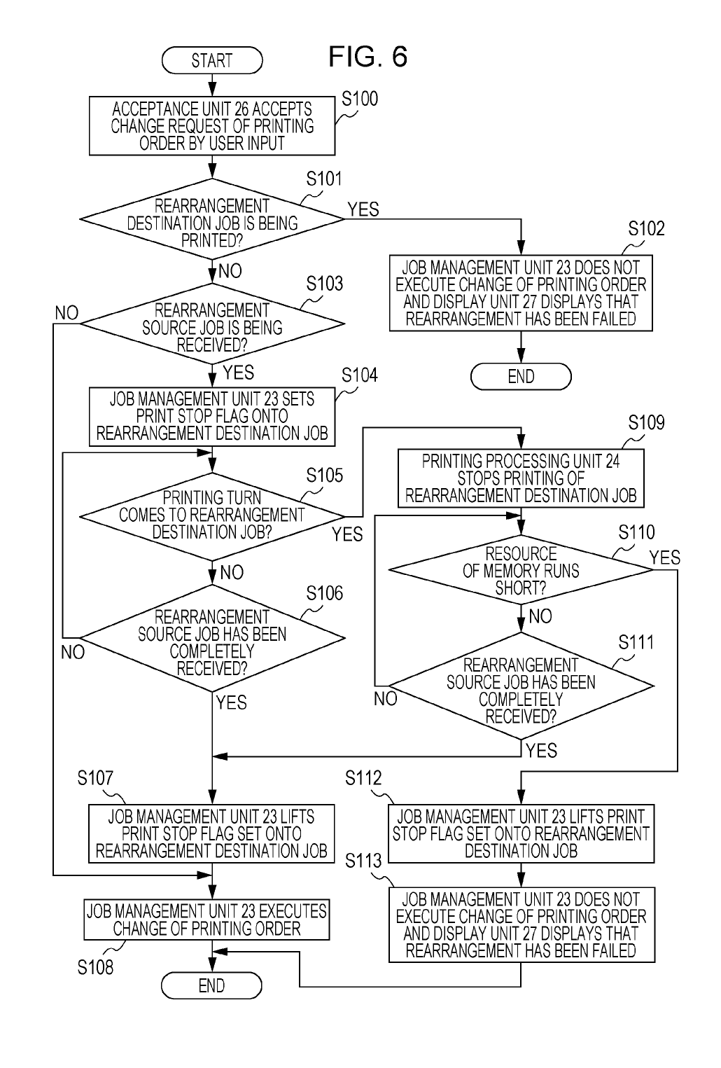

Hereinafter, a job processing method which is executed in the printing apparatus 20 is described with reference to a flowchart as illustrated in FIG. 6. The order of processes (including a partial process designated with no reference numeral) can be arbitrarily changed or the processes can be executed in parallel within a range causing no contradiction in processing contents. Note that the job processing method is described by examplifying a case in which the print jobs held in the print waiting line are in the following states. That is, the print job A is being received, the print jobs B, C, D have been completely received and are unprinted and the print job E has been completely received and is being printed as illustrated in FIG. 5. Further, description is given under the following assumption. That is, a print job of which printing order is desired to be made earlier by a user is assumed to be “rearrangement source job”. Further, a print job to which a turn of printing comes subsequent to the rearrangement source job after the printing order has been rearranged among print jobs held in the print waiting line is assumed to be “rearrangement destination job”.

At first, the acceptance unit 26 accepts a change request of the printing order by a user input (step S100). For example, a user selects the print job A as the rearrangement source job through the operation unit 203. Further, the printing order of the print job A is designated to be made before the print job D by the user. Then, the acceptance unit 26 can accept information of the rearrangement source job (print job A) and the rearrangement destination job (print job D) as a change request of the printing order.

Next, the job management unit 23 judges whether or not the rearrangement destination job is being printed (step S101). When the rearrangement destination job is being printed (step S101: Yes), rearrangement cannot be performed. Therefore, the job management unit 23 does not change the printing order and the display unit 27 displays that the rearrangement has failed on a display on the operation unit 203 or the like (step S102). For example, when the rearrangement destination job is the print job E which is being currently printed, the rearrangement of the printing order fails.

On the other hand, when the rearrangement destination job is not being printed (step S101: No), the job management unit 23 judges whether or not the rearrangement source job is being received (step S103). When the rearrangement source job is not being received (step S103: No), the job management unit 23 changes the printing order (step S108). For example, if the rearrangement source job is the print job A and the rearrangement destination job is the print job D, the printing order is changed from the order of A→B→C→D→E to the order of B→C→D→A→E in step S108.

When the rearrangement source job is being received (step S103: Yes), the job management unit 23 sets a print stop flag onto the rearrangement destination job (step S104). The print stop flag is a flag for stopping execution of the printing processing by the printing processing unit 24. For example, if the rearrangement destination job is the print job D and the print stop flag is set onto the print job D, the print job D is not processed by the printing processing unit 24.

Next, after the print stop flag has been set, the job management unit 23 waits for the change processing of the printing order until the rearrangement of the rearrangement source job is made possible. That is, the job management unit 23 waits for the change processing of the printing order until the rearrangement source job is completely received. To be more specific, the job management unit 23 judges whether or not a turn of the printing comes to the rearrangement destination job (step S105) and judges whether or not the rearrangement source job has been completely received (step S106).

When it has not been judged that the turn of the printing comes to the rearrangement destination job (step S105: No), and it has not been judged that the rearrangement source job has been completely received (step S106: No), the process returns to the processing in step S105.

When it has been judged that the rearrangement source job has been completely received (step S106: Yes), the job management unit 23 lifts the print stop flag set onto the rearrangement destination job (step S107) and changes the printing order (step S108).

On the other hand, when it has been judged that the turn of the printing comes to the rearrangement destination job in the processing in step S105 (step S105: Yes), the printing processing unit 24 stops the printing processing of the rearrangement destination job (step S109). That is to say, since the print stop flag is set onto the rearrangement destination job, the printing processing unit 24 automatically stops the printing processing of the rearrangement destination job.

After the processing in step S109, the job management unit 23 waits for the change processing of the printing order until the rearrangement source job is completely received while monitoring shortage of the resource of the memory 29. To be more specific, the job management unit 23 judges whether or not the resource of the memory 29 runs short (step S110) and judges whether or not the rearrangement source job has been completely received (step S111).

When it has been judged that the resource of the memory 29 runs short (step S110: Yes), the rearrangement source job cannot be completely received while waiting for a time where the rearrangement of the rearrangement source job is made possible because the resource of the memory 29 runs short. Therefore, the job management unit 23 lifts the print stop flag set onto the rearrangement destination job (step S112). Next, the job management unit 23 does not change the printing order and the display unit 27 displays that the rearrangement has failed on a display on the operation unit 203 or the like (step S113).

When it has not been judged that the resource of the memory 29 runs short (step S110: No) and it has not been judged that the rearrangement source job has been completely received (step S111: No), the process returns to the processing in step S110. When it has been judged that the rearrangement source job has been completely received (step S111: Yes), the job the management unit 23 lifts the print stop flag set onto the rearrangement destination job (step S107) and changes the printing order (step S108).

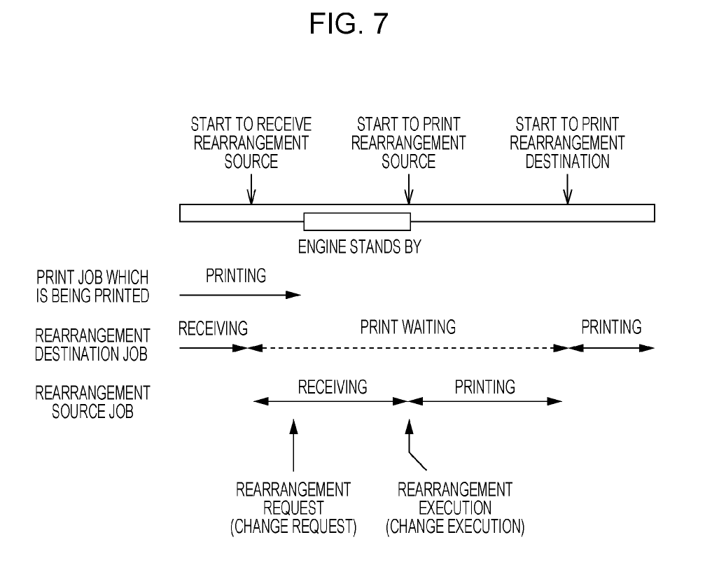

After each processing in steps S102, S108 or S113 is performed, the processing flow ends. It is assumed that three print jobs are sequentially received and print-processed and a print job which is received second is assumed to be a rearrangement destination job and a print job which is received third is assumed to be a rearrangement source job. In such a case, an example of a time chart when the above processing flow has been executed is illustrated in FIG. 7. As is understood from FIG. 7, in a case where a change request of the printing order has been accepted when the rearrangement source job is being received, if a turn of the printing comes to the rearrangement destination job before the rearrangement source job is completely received, the rearrangement is performed even by stopping the printing processing of the rearrangement destination job. Therefore, the printing order of the rearrangement source job comes before the rearrangement destination job.

As described above, with the printing apparatus (job processing apparatus) and the job processing method according to the embodiment, a change request of a printing order of a print job which is being received can be accepted. Further, when the print job which is being received is targeted to be rearranged, the rearrangement of the printing order is not executed until the print job which is being received is completely received. When the rearrangement source job has been completely received before a turn of the printing comes to the rearrangement destination job, the printing order is rearranged. When the turn of the printing comes to the rearrangement destination job before the rearrangement source job is completely received, the rearrangement in accordance with the change request by a user is executed to the extent as possible even by stopping the printing of the rearrangement destination job. For example, while a print job is being printed, 100 print jobs which are unprinted are assumed to be rearrangement destination jobs and one print job which is being received is assumed to be a rearrangement source job. In this case, if the rearrangement destination jobs are started to be printed before the rearrangement source job is completely received, the rearrangement source job is started to be printed after the 100 rearrangement destination jobs have been completely printed. However, according to the embodiment, the print job which is being received can be printed as fast as possible by stopping the printing processing of the rearrangement destination jobs. Further, when the printing processing of the rearrangement destination jobs are stopped and the resource of the memory 29 runs short, the rearrangement destination jobs are started to be printed and the printing processing is controlled as rearrangement failure. Accordingly, an empty storage region of the memory 29 can be ensured when the printing of the rearrangement destination jobs have been completed. Therefore, limitation of the storage space of the memory 29 can be eliminated.

### First Variation of Job Processing Method

In the above embodiment, when the printing order of the print job (rearrangement source job) which is being received is changed to the one before the print job (rearrangement destination job) in the print waiting state, the printing order is not changed if the change of the printing order is made impossible due to shortage of the resource of the memory 29 while waiting for a time where the rearrangement of the rearrangement source job is made possible. However, the invention is not limited thereto. For example, a configuration in which the rearrangement destination job is changed and the preceding rearrangement destination job is print-processed and deleted from the memory 29 so that the empty storage space of the memory 29 is ensured and the printing order is changed may be employed. In this case, the job management unit 23 has the following function in addition to the above functions. That is, the job management unit 23 judges whether or not the resource of the memory 29 runs short while the processing by the printing processing unit 24 is stopped. When the job management unit 23 has judged that the resource of the memory 29 runs short and a print job (third job) which is processed subsequent to the second job is held in the memory 29, the job management unit 23 changes information of the second job to information of the third job (changes the rearrangement destination job) in the change request to change the processing order after the first job has been completely received.

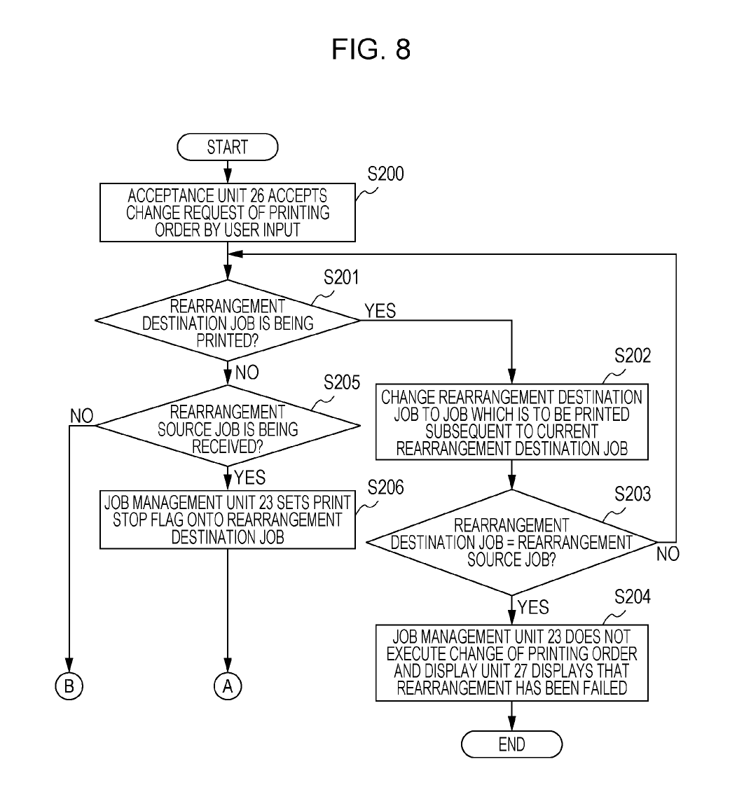

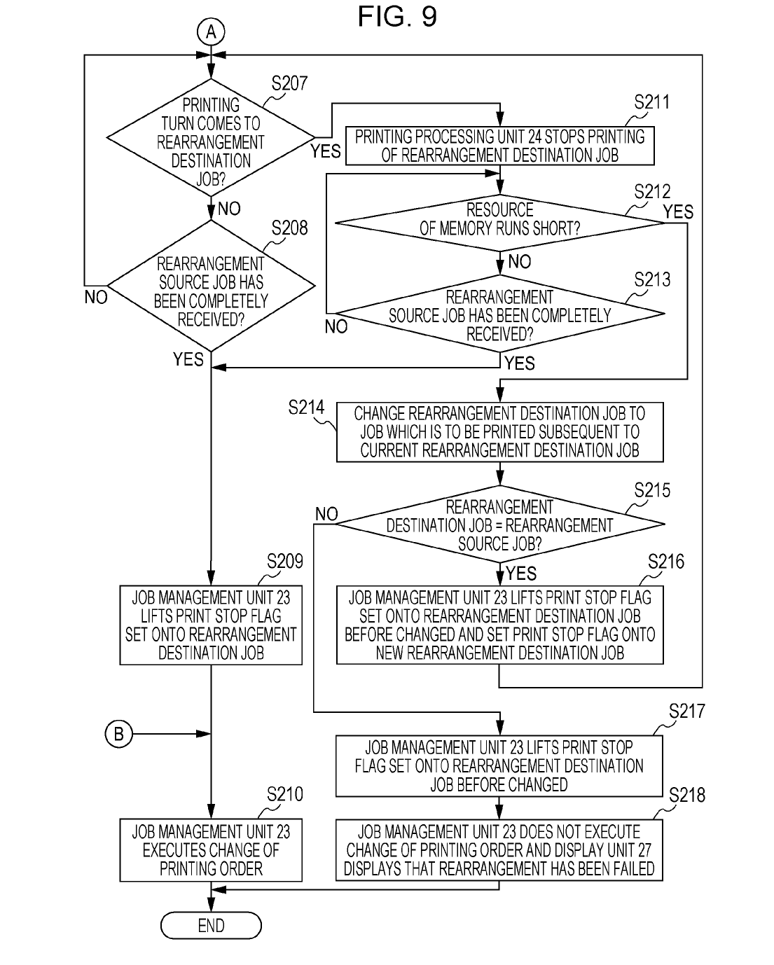

A processing flow according to the first variation of the embodiment is described with reference to flowcharts as illustrated in FIG. 8 and FIG. 9.

At first, the acceptance unit 26 accepts a change request of the printing order by a user input (step S200). Next, the job management unit 23 judges whether or not the rearrangement destination job is being printed (step S201). When the rearrangement destination job is being printed (step S201: Yes), rearrangement of the current rearrangement destination job cannot be performed. Therefore, the job management unit 23 changes the rearrangement destination job to a print job which is to be printed subsequent to the current rearrangement destination job (step S202). For example, description is given by using the print jobs as illustrated in FIG. 5 as an example. When the rearrangement destination job is assumed to be the print job E, the rearrangement destination job is changed to the print job D which is to be printed subsequent to the print job E.

After the rearrangement destination job has been changed in step S202, it is judged whether or not the rearrangement destination job and the rearrangement source job are the same (step S203). When the rearrangement destination job and the rearrangement source job are not the same (step S203: No), the process proceeds to step S201. When the rearrangement destination job and the rearrangement source job are the same (step S203: Yes), the printing order cannot be changed. Therefore, the job management unit 23 does not change the printing order and the display unit 27 displays that the rearrangement has failed on a display of the operation unit 203 or the like (step S204).

On the other hand, when the rearrangement destination job is not being printed (step S201: No), the job management unit 23 judges whether or not the rearrangement source job is being received (step S205). When the rearrangement source job is not being received (step S205: No), the job management unit 23 changes the printing order (step S210).

When the rearrangement source job is being received (step S205: Yes), the job management unit 23 sets a print stop flag onto the rearrangement destination job (step S206).

Next, the job management unit 23 waits for the change processing of the printing order until the rearrangement of the rearrangement source job is made possible after the print stop flag has been set. To be more specific, the job management unit 23 judges whether or not a turn of the printing comes to the rearrangement destination job (step S207) and judges whether or not the rearrangement source job has been completely received (step S208).

When it has not been judged that the turn of the printing comes to the rearrangement destination job (step S207: No), and it has not been judged that the rearrangement source job has been completely received (step S208: No), the process returns to the processing in step S207.

When it has been judged that the rearrangement source job has been completely received (step S208: Yes), the job management unit 23 lifts the print stop flag set onto the rearrangement destination job (step S209) and changes the printing order (step S210).

On the other hand, when it has been judged that the turn of the printing comes to the rearrangement destination job in the processing in step S207 (step S207: Yes), the printing processing unit 24 stops the printing processing of the rearrangement destination job (step S211).

After the processing in step S211, the job management unit 23 waits for the change processing of the printing order until the rearrangement source job is completely received while monitoring shortage of the resource of the memory 29. To be more specific, the job management unit 23 judges whether or not the resource of the memory 29 runs short (step S212) and judges whether or not the rearrangement source job has been completely received (step S213).

When it has been judged that the resource of the memory 29 runs short (step S212: Yes), the rearrangement source job cannot be completely received. Therefore, the job management unit 23 changes the current rearrangement destination job to a print job which is to be printed subsequent to the current rearrangement destination job (step S214). That is to say, the job management unit 23 print-processes a print job which has been the rearrangement destination job before changed and deletes the print job from the memory 29 so that an empty storage space of the memory 29 can be ensured and the rearrangement source job can be completely received.

After the rearrangement destination job has been changed in step S214, it is judged whether or not the rearrangement destination job and the rearrangement source job are the same (step S215). When the rearrangement destination job and the rearrangement source job are not the same (step S215: No), the job management unit 23 lifts the print stop flag set onto the rearrangement destination job before changed and sets the print stop flag on a new rearrangement destination job (step S216). Then, the process proceeds to step S207. On the other hand, when the rearrangement destination job and the rearrangement source job are the same (step S215: Yes), the printing order cannot be changed. Therefore, the job management unit 23 does not change the printing order and lifts the print stop flag set onto the rearrangement destination job before changed (step S217) and the display unit 27 displays that the rearrangement has failed on a display on the operation unit 203 or the like (step S218).

After each processing in steps S204, S210 or S218 has been performed, the processing flow ends.

As described above, according to the processing flow, when the printing order is changed such that the print job (rearrangement source job) which is being received is printed before the print job (rearrangement destination job) in the print waiting state, the following processings are performed. That is, if the change of the printing order is made impossible due to shortage of the resource of the memory 29 while waiting for reception completion of the print job which is being received, that is, while waiting for a time where the rearrangement source job can be made possible, the rearrangement destination job is changed and the preceding rearrangement destination job is print-processed and is deleted from the memory 29. Therefore, the empty storage region of the memory 29 is ensured and the printing order is changed. As a result, the print job which is desired to be rearranged by a user can be automatically set such that the print job is printed at a desired order or at an order earlier than the desired order to the extent as possible.

### Second Variation of Job Processing Method

In the above embodiment, when the printing order of the print job (rearrangement source job) which is being received is changed to the one before the print job (rearrangement destination job) in the print waiting state, the printing order is not changed if the change of the printing order is made impossible due to shortage of the resource of the memory 29 while waiting for a time till the rearrangement of the rearrangement source job is made possible. However, the invention is not limited thereto. For example, the following configuration can be employed. That is, the printing apparatus 20 includes an external storage medium (for example, USB memory or the like) 30 which is detachable and the external storage medium 30 is used in order to ensure the empty storage region of the memory 29. With this, the change of the printing order can be made possible. To be more specific, the print job held in the memory 29 is stored in the external storage medium 30 and the stored print job is deleted from the memory 29 so that the empty storage region of the memory 29 can be ensured. In this case, the job management unit 23 has the following function in addition to the above functions. That is, the job management unit 23 has a function to swap out at least one job held in the memory to the external storage medium when a turn of the processing by the printing processing unit 24 comes to the print destination job while waiting for reception completion.

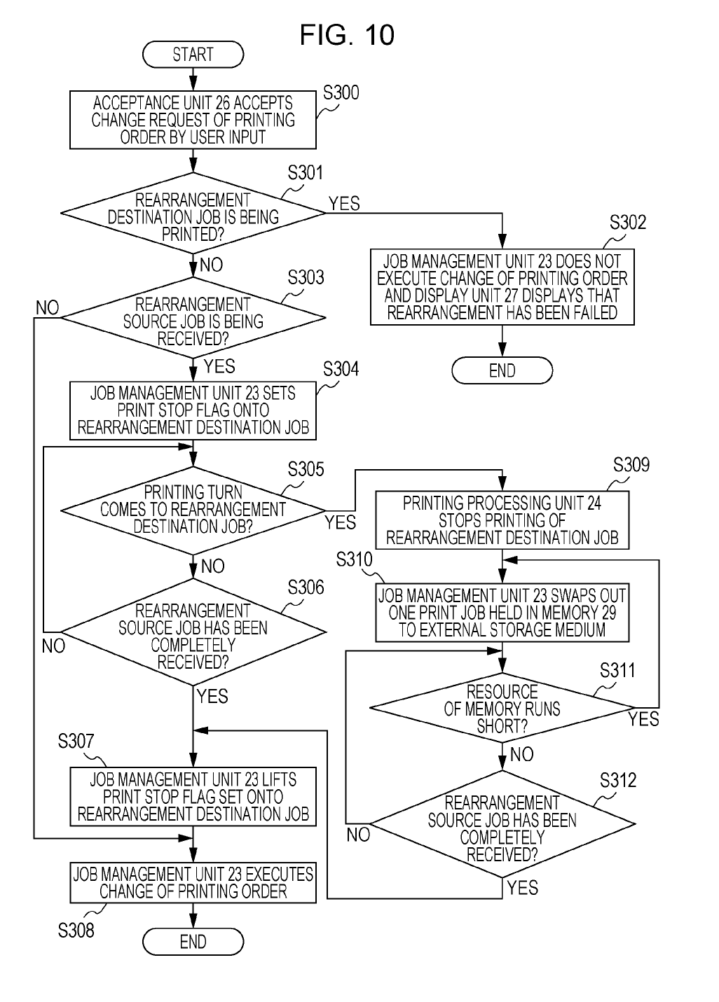

A processing flow according to the second variation of the embodiment is described with reference to a flowchart as illustrated in FIG. 10. It is to be noted that since the processings in steps S300 through S309 can be made to be the same as the processings in steps S100 through S109 in principle, detail description thereof is not repeated.

In the second variation of the embodiment, when it has been judged that the turn of the printing comes to the rearrangement destination job in the processing in step S305 (step S305: Yes), the job management unit 23 swaps out one print job held in the memory 29 to the external storage medium 30 (step S310). For example, as illustrated in FIG. 5, when the print jobs A through E are held in the memory 29, the print job D is stored in the external storage medium 30 and the print job D is deleted from the memory 29 so that the resource of the memory 29 can be ensured.

After the processing in step S310, the job management unit 23 waits for a change processing of the printing order until the rearrangement source job is completely received while monitoring shortage of the resource of the memory 29. To be more specific, the job management unit 23 judges whether or not the resource of the memory 29 runs short (step S311) and judges whether or not the rearrangement source job has been completely received (step S312).

When it has been judged that the resource of the memory 29 runs short (step S311: Yes), if there are unprinted print jobs held in the memory 29, the process proceeds to step S310.

When it has not been judged that the resource of the memory 29 runs short (step S311: No) and it has not been judged that the rearrangement source job has been completely received (step S312: No), the process returns to the processing in step S311. When it has been judged that the rearrangement source job has been completely received (step S312: Yes), the job management unit 23 lifts the print stop flag set onto the rearrangement destination job (step S307) and changes the printing order (step S308).

In the processing in the above step S310, a case in which one print job held in the memory 29 is swapped out to the external storage medium has been described as an example. However, the print job to be swapped out is not limited to one and may be set to be at least one print job. For example, if a configuration in which all the print jobs held in the memory 29 are swapped out to the external storage medium 30 is employed, the resource of the memory 29 can be ensured as much as possible. In this case, processings in the above steps S311 through S312 are not performed.

As described above, with the processing flow, when the external storage medium which is detachable is included and the turn of the processing by the printing processing unit 24 comes to the rearrangement destination job while waiting for the reception completion, at least one print job held in the memory 29 is swapped out to the external storage medium. With this, a state in which the printing order is not changed due to shortage of the resource of the memory 29 can be prevented from occurring. Further, the empty storage region of the memory 29 can be ensured so that limitation of the storage space of the memory 29 can be eliminated.

### Variations

The preferred embodiment according to the invention has been described above. However, the invention is not limited to the above embodiment and various modifications, addition, and omission can be made by those skilled in the art without departing from the spirit and range of the scope of the invention.

For example, in the above embodiment, the printing apparatus has been described as an example of a job processing apparatus. However, the invention is not limited thereto and can be applied to various job processing apparatuses using a job processing waiting line, for example, to devices such as a complex machine, a copying machine, and a facsimile machine. It is to be noted that for example, the complex machine and the copying machine can receive a job from the scanner device and the facsimile machine can receive a job from an external facsimile machine.

Further, in the above embodiment, a case in which a display unit which displays a result of change of the processing order by the job management unit is included has been described as an example. However, the invention is not limited thereto and a sound source for transmitting completion of change of the processing order by voice may be included, for example.

Further, in the above embodiment, various parts are included in the printing apparatus 20 depending on purposes. However, these parts may be configured such that some of the parts are integrally formed or one part is further divided into a plurality of parts.

Further, in the above embodiment, a configuration in which the parts having each processing function are included in the printing apparatus 20 has been described. However, the invention is not limited thereto. A configuration in which each part is included on network or in another device which is connected to the user terminal 10 and the printing apparatus 20 in a communicable manner can be employed.

The entire disclosure of Japanese Patent Application No. 2010-111441, filed May 13, 2010 is expressly incorporated by reference herein.

What is claimed is:

1. A job processing apparatus comprising:
a reception unit which receives a job;
a job management unit which holds the job received by the reception unit in a memory and manages a processing order of a plurality of jobs held in the memory;
a job processing unit which sequentially processes the plurality of jobs in accordance with the processing order; and
an acceptance unit which accepts a change request of the processing order for changing to an order in which a first job which is being received by the reception unit is processed before a predetermined second job among the held jobs,
wherein when the acceptance unit has accepted the change request, the job management unit changes the processing order, and when a turn of the processing by the job processing unit comes to the second job before the processing order is changed in accordance with the change request, the job management unit stops the processing by the job processing unit and changes the processing order.

2. The job processing apparatus according to claim 1,
wherein when the acceptance unit has accepted the change request, the job management unit changes the processing order after the first job has been completely received, and when a turn of the processing by the job processing unit comes to the second job while waiting for the reception completion, the job management unit stops the processing by the job processing unit and changes the processing order after the first job has been completely received.

3. The job processing apparatus according to claim 1,
wherein the job management unit judges whether or not a resource of the memory runs short while the processing by the job processing unit is stopped and when it has been judged that the resource runs short, the job management unit restarts the processing by the job processing unit and does not change the processing order in accordance with the change request of the processing order.

4. The job processing apparatus according to claim 1,
wherein the job management unit judges whether or not a resource of the memory runs short while the processing by the job processing unit is stopped and when it has been judged that the resource runs short and a third job which is to be processed subsequent to the second job is held in the memory, the job management unit changes information of the second job to information of the third job in the change request and changes the processing order after the first job has been completely received.

5. The job processing apparatus according to claim 1,
wherein the job processing apparatus includes an external storage medium which is detachable, and
when a turn of the processing by the job processing unit comes to the second job while waiting for the reception completion, the job management unit swaps out at least one job held in the memory to the external storage medium.

6. The job processing apparatus according to claim 1, further including a display unit which displays a result of the change of the processing order by the job management unit.

7. A job processing method comprising:
receiving a job;
holding the received job in a memory and managing a processing order of a plurality of jobs held in the memory;
sequentially processing the plurality of jobs in accordance with the processing order;
accepting a change request of the processing order for changing to an order in which a first job which is being received is processed before a predetermined second job among the held jobs; and
when the change request has been accepted, executing the change of the processing order, and when a turn of the processing comes to the second job before the processing order is changed in accordance with the change request, stopping the processing of the second job and executing the change of the processing order.
